(19) United States
(12) Patent Application Publication
(10) Pub. No.: US 2019/0377442 A1
(43) Pub. Date: Dec. 12, 2019

(54) TOUCH PANEL AND METHOD FOR PRODUCING THE SAME

(71) Applicant: Wuhan China Star Optoelectronics Semiconductor Display Technology Co., Ltd., Wuhan (CN)

(72) Inventor: XIAOLIANG FENG, SHENZHEN (CN)

(21) Appl. No.: 16/207,224

(22) Filed: Dec. 3, 2018

Related U.S. Application Data
(63) Continuation of application No. PCT/CN2018/097400, filed on Jul. 27, 2018.

(30) Foreign Application Priority Data
Jun. 12, 2018 (CN) 201810603911.1

(51) Int. Cl. G06F 3/047; G06F 3/041

(52) U.S. Cl. CPC G06F 3/047; G06F 3/0412

(57) ABSTRACT

The present disclosure provides a touch panel and a method for producing the same. The touch panel includes a touch substrate and a touch electrode layer disposed on the touch substrate. The touch electrode layer includes an electrode layer, a connection layer and an insulating layer disposed between the electrode layer and the connection line layer. The electrode layer includes a plurality of first electrodes and second electrodes arranged in rows and columns. The connection line layer includes first connection lines disposed above or below the electrode layer, and each of the first connecting lines is insulated from the first electrode of all the rows except the corresponding row. The touch panel further includes a protective layer disposed on the touch electrode layer.

### CROSS-REFERENCE TO RELATED APPLICATIONS

The present application is a continuation-application of International (PCT) Patent Application No. PCT/CN2018/097400 filed on Jul. 27, 2018, which claims foreign priority of Chinese Patent Application No. 201810603911.1, filed on Jun. 12, 2018 in the State Intellectual Property Office of China, the entire contents of which are hereby incorporated by reference.

### TECHNICAL FIELD

The present disclosure relates to a technical field of display technology, and particularly to a touch panel and a producing method thereof.

### BACKGROUND

Full-screen display has become a trend in the current market. In order to adapt to this display style, various display manufacturers have adopted various design methods to reduce the width of the display-free area at the edge of the display, that is, to reduce the width of the display frame.

A touch screen is the important part of a display screen. The production of the narrow frame of the touch screen will seriously affect the effect of full-screen display, so the full-screen of the touch screen with a narrow frame of touch has also become a trend of technology development. At present, the touch electrodes of the touch electrode lines in the touch screen are connected to the solder region, solder pad, by means of edge routing, which causes the edge space of the display screen to be excessively occupied, and increase the width of the non-touch area, so that the display frame borders widening. It is difficult to achieve borderless narrow border requirements for large touch screens.

### SUMMARY

This present disclosure provides a touch panel and a method for producing the same, which may avoid the influence of edge traces on the border of the touch panel, greatly reduce the width of the border, and even realize a zero border.

In order to solve the above technical problem, one of the technical solutions adopted in the present disclosure is to provide a touch panel. The touch panel may include a touch substrate and a touch electrode layer disposed on the touch substrate. The touch electrode layer may include an electrode layer, a connection line layer and an insulation layer. The insulation layer may be disposed between the electrode layer and the connection line layer. The electrode layer may include a plurality of first electrodes and second electrodes arranged in rows and columns, and the connection line layer may include first connection lines disposed above or below the electrode layer. Each row of the first electrodes may be respectively connected to the solder region through a corresponding first connection line, and each of the first connection lines may be insulated from the first electrodes of all the rows except the corresponding row. The electrode layer may be formed on the touch substrate, the insulation layer may be formed on the electrode layer, and the connection line layer may be formed on the insulation layer. The connection line layer may include a plurality of the first connection lines, a plurality of second connection lines, and a plurality of bridge lines. The bridge lines may be disposed between adjacent second electrodes of each column for connecting the second electrodes of the same column. The second connection lines may be configured to connect the corresponding second electrodes of each column to the soldering region. Alternatively, the connection line layer may be formed on touch substrate, including a plurality of the first connection lines, a plurality of second connection lines, and a plurality of bridge lines. The insulation layer may be formed on the connection line layer, and the electrode layer may be formed on the insulation layer. The bridge lines may be disposed between adjacent second electrodes in each column for connecting the second electrodes of the same column. The second connection lines may be configured to connect the corresponding second electrodes of each column to the soldering region. The touch panel may further include a protective layer disposed on the touch electrode layer.

In order to solve the above technical problem, another technical solution adopted in the present disclosure is to provide a touch panel. The touch panel may include a touch substrate and a touch electrode layer disposed on the touch substrate. The touch electrode layer may include an electrode layer, a connection line layer and an insulation layer. The insulation layer may be disposed between the electrode layer and the connection line layer. The electrode layer may include a plurality of first sensing electrodes, a plurality of first electrodes and second electrodes arranged in rows and columns, and the connection line layer may include first connection lines disposed above or below the electrode layer. Each row of the first electrodes may be respectively connected to the solder region through a corresponding first connection line, and each of the first connection lines may be insulated from the first electrodes of all the rows except the corresponding row. The touch panel may further include a protective layer disposed on the electrode layer.

In order to solve the above technical problem, another technical solution adopted in the present disclosure is to provide a method for producing a touch panel, the method may comprise: providing a touch substrate; preparing a touch electrode layer on the touch substrate. The touch electrode layer may include an electrode layer, a connection line layer and an insulation layer. The insulation layer may be disposed between the electrode layer and the connection line layer. The electrode layer may include a plurality of first electrodes and second electrodes arranged in rows and columns. The connection line layer may include first connection lines disposed above or below the electrode layer. Each row of the first electrodes may be respectively connected to the solder region through a corresponding first connection line, and each of the first connection lines may be insulated from the first electrodes of all the rows except the corresponding row. The method may also comprise: preparing a protective layer on the touch electrode layer as to form the touch panel.

The beneficial effect of the above embodiments lies in that: the present disclosure provides a touch panel and method for producing a touch panel. By disposing the first connection lines of the connection line layer above or below the electrode layer, that is, connecting the sensing electrode to the solder region from the inner trace of the electrode layer, the influence of the edge tracing on the touch panel frame may be avoided. Greatly reduce the width of the display frame border, and even achieve a zero border design.

### BRIEF DESCRIPTION OF THE DRAWINGS

FIG. 1 is a schematic flow chart of an embodiment of a method for producing a touch panel of the present application.

FIG. 2 is a schematic structural view of an embodiment of a touch panel provided by present disclosure.

FIG. 3 is another schematic structural view of an embodiment of a touch panel provided by the present disclosure.

FIG. 4 is another schematic structural view of an embodiment of a touch panel provided by the present disclosure.

FIG. 5 is a schematic flow chart of an embodiment of block S2 in FIG. 1 of the present application.

FIG. 6 is a schematic structural view of an embodiment of a touch electrode layer provided by the present disclosure.

FIG. 7 is a schematic structural view of an embodiment of a bridge point of the present disclosure.

FIG. 8 is a schematic flow chart of another embodiment of a method for producing a touch panel of the present disclosure.

FIG. 9 is a schematic structural view of another embodiment of a touch panel provided by the present disclosure.

FIG. 10 is another schematic structural view of another embodiment of a touch panel provided by the present disclosure.

FIG. 11 is another schematic structural view of another embodiment of a touch panel provided by the present disclosure.

### DETAILED DESCRIPTION

The technical solutions in the embodiments of the present disclosure will be clearly described as follows. Apparently, the described embodiments are merely a part but not all of the embodiments of the present disclosure. All other embodiments obtained by the ordinary skilled in the art according to the embodiments of the present disclosure without any creative efforts shall fall into the protection scope of the present disclosure.

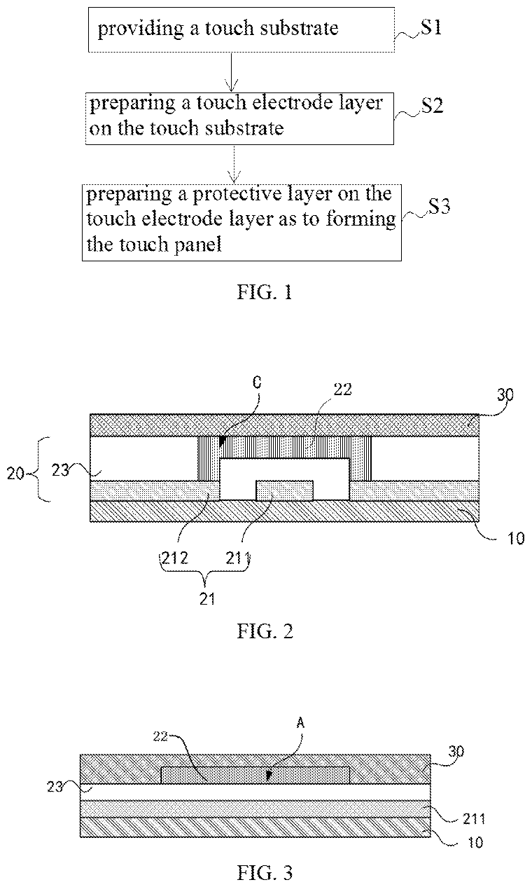

Referring to FIG. 1, FIG. 1 is a schematic flow chart of an embodiment of a method for producing a touch panel of the present application. As shown in FIG. 1, the method for producing a touch panel in the embodiment may include the following blocks:

S1: providing a touch substrate.

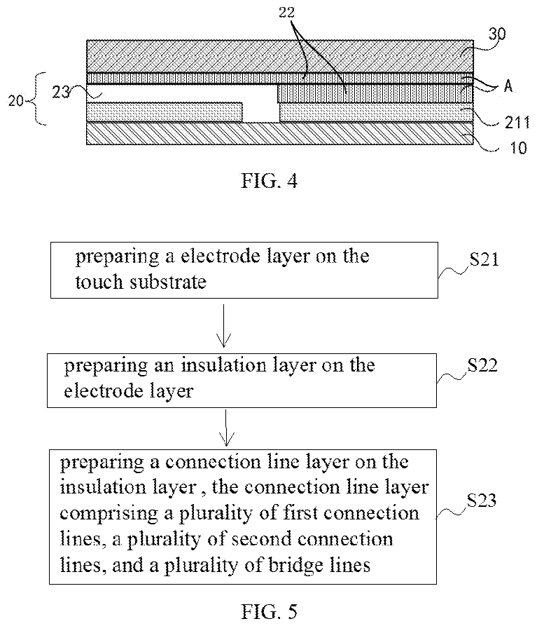

Also referring to FIG. 2 to FIG. 4. FIG. 2, FIG. 3 and FIG. 4 are respectively three different schematic structural views of an embodiment of a touch panel provided by the present disclosure. And in block S1, a touch substrate 10 is provided at first. The touch substrate 10 may be a transparent material, and specifically may be any substrate such as glass, ceramic substrate or transparent plastic, or may be an organic film substrate such as a polyvinyl chloride (PVC) substrate or a Cyclo-olefinpolymer (COP) substrate.

S2: preparing a touch electrode layer on the touch substrate.

Further, a touch electrode layer 20 may be formed on the touch substrate 10, wherein the touch electrode layer 20 may include an electrode layer 21, a connection line layer 22, and an insulation layer 23. In a specific embodiment, the insulation layer 23 may be disposed between the electrode layer 21 and the connection line layer

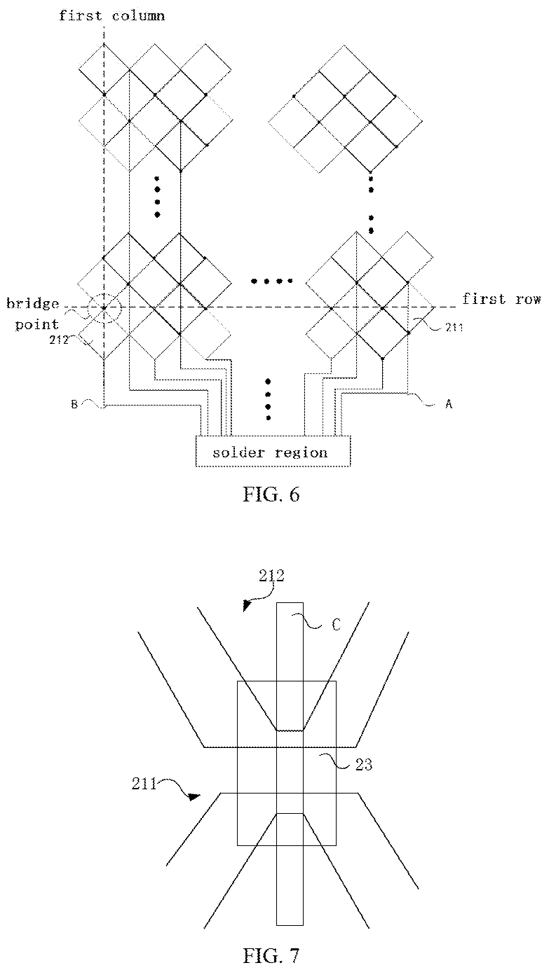

Alternatively referring to FIG. 5, block S2 may further include the following sub-blocks:

S21, producing an electrode layer on the touch substrate.

Further referring to FIG. 6, FIG. 6 is a schematic structural view of an embodiment of a touch electrode layer provided by the present disclosure. In this embodiment, a patterned electrode layer 21 may be first prepared on the touch substrate 10, wherein the electrode layer 21 may further include a plurality of first electrodes 211 and second electrodes 212 disposed in rows and columns. The adjacent first electrodes 211 of each row are directly connected. In this embodiment, the first electrode 211 and the second electrode 212 may respectively be a sensing electrode (Rx) and a driving electrode. In other embodiments, the first electrode 211 may also be a driving electrode, and the second electrode 212 may also be a sensing electrode (Rx), which is not further limited herein. Alternatively, the first electrode 211 and the second electrode 212 in this embodiment may have a diamond shape, a metal mesh, or other related shapes, and is not further limited herein. In the present application, a diamond pattern is taken as an example for explanation. The material of the electrode layer 21 may be indium tin oxide, or one of aluminum, copper, silver, titanium, molybdenum and alloys thereof, which is not further limited herein.

S22: preparing an insulation layer on the electrode layer.

Further, an insulation layer 23 may be forced on the touch substrate 10 having the patterned electrode layer 21 described above. The insulation layer 23 may be made of a material such as a transparent adhesive, and may be other materials in other embodiments, and is not further limited herein.

S23: preparing a connection line layer on the insulation layer. The connection line layer may include a plurality of first connection lines, a plurality of second connection lines and a plurality of bridge lines.

Further referring to FIG. 2 to FIG. 6. The connection line layer 22 may include a plurality of first connection lines A, a plurality of second connection lines B and a plurality of bridge lines C. Each row of the first electrodes 211 may respectively connected to the solder region through a corresponding first connection line A. Each of the first connection lines A may be insulated from the first electrodes 211 of all the rows except the corresponding row. Alternatively, the insulation layer 23 may be disposed between each first connection line A and the first electrodes 211 of all the rows except the corresponding row by action S22, so that the first connection line A may connect the first electrode 211 of the corresponding row to the solder region (bonding), and be simultaneously insulated from all the first electrodes 211 of the other rows.

In the present disclosure, the intersection of the first electrodes 211 and the second electrodes 21 disposed in a plurality of rows and columns is bridge points. Referring to FIG. 7, FIG. 7 is a schematic structural view of an embodiment of a bridge point of the present disclosure. A plurality of bridge lines C may be disposed between adjacent second electrodes 212 of each column for connecting together the second electrodes 212 of the same column. A plurality of second connection lines B may be used for respectively connecting a corresponding column of second electrodes 212 to the solder region.

The materials of a plurality of the first connection lines A, a plurality of the second connection lines B, and a plurality of the bridge lines C in this embodiment may also be one of indium tin oxide or aluminum, copper, silver, titanium, molybdenum and alloys thereof, which is not further limited here.

Further referring to FIG. 2 to FIG. 4. In the present disclosure, the first connection lines A of the first electrodes 211 and the second connection lines B of the second electrodes 212 may be disposed in a manner that the solder regions are cross-distributed.

In the present embodiment, by disposing the first connection lines A above the electrode layer 21, that is, by routing from the inside of the electrode layer 21, the first connection lines A are connected to the solder region. Compared with the conventional tracing from the electrode layer edge, the technical solution adopted in this embodiment may avoid the influence of the edge tracing on the border of the touch panel, greatly reduce the width of the display frame border, and even achieve a zero border design.

S3: preparing a protective layer on the touch electrode layer.

After the preparation of the touch electrode layer 20 described above is completed, the protective layer 30 may be further deposited. The preparation of the protective layer 30 may be prepared by using conventional materials or conventional techniques, and is not further limited herein.

In the above embodiment, by disposing the first connection lines of the connection line layer above the electrode layer, that is, by routing from the inside of the electrode layer, the first connection lines are connected to the solder region, the influence of the edge tracing on the touch panel frame can be avoided. Greatly reduce the width of the display frame border, and even achieve a zero border design.

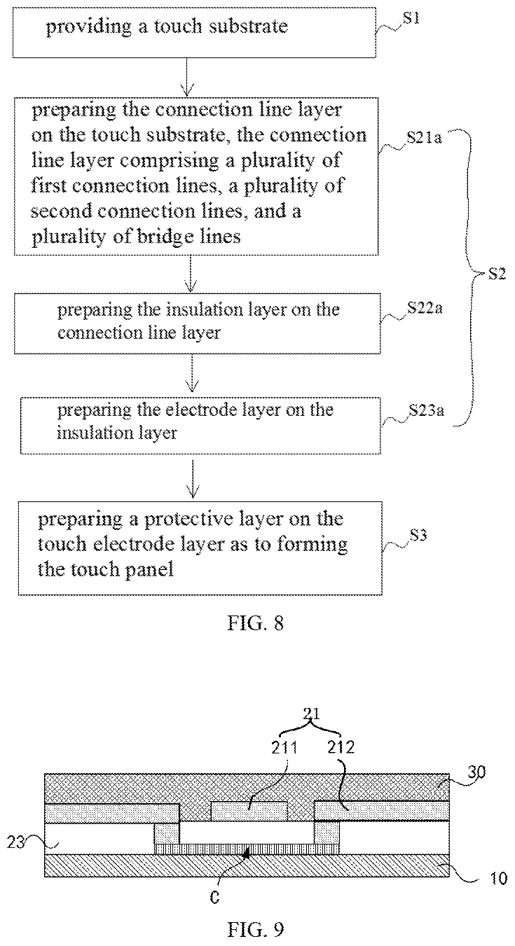

Referring to FIG. 8, FIG. 8 is a schematic flow chart of another embodiment of a touch panel producing method according to the present disclosure. The producing method of this embodiment may be substantially the same as that of the embodiment mentioned above. The difference is that the electrode layer and the connection line layer in the touch electrode layer may be prepared in different order. In this embodiment, the connection line layer may be prepared on the touch substrate at first, and then the insulation layer and the electrode layer may be prepared in sequence. The same as in the above embodiment is not further described herein. The details of the producing method of this embodiment are as follows:

S1, providing a touch substrate.

S2, preparing a touch electrode layer on the touch substrate.

A touch electrode layer 20 may be prepared on the touch substrate 10, wherein the touch electrode layer 20 may include an electrode layer 21, a connection line layer 22, and an insulation layer 23. In a specific embodiment, the insulation layer 23 may be disposed between the electrode layer 21 and the connection line layer 22.

Action S2 may further include the following sub-actions:

S21a, preparing a connection line layer on the touch substrate. The connection line layer may include a plurality of first connection lines, a plurality of second connection lines, and a plurality of bridge lines.

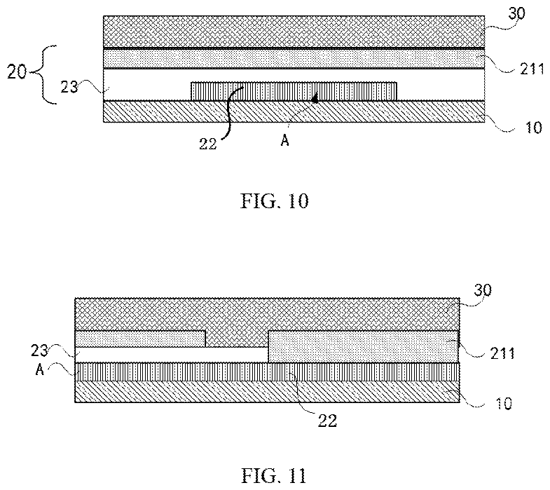

Referring to FIG. 9-11, FIG. 9-11 are respectively different schematic structural views of another embodiment of the touch panel of the present disclosure.

In this embodiment, also combined with referring to FIG. 6, the connection line layer 22 may be prepared on the touch substrate 10 at first. The connection line layer 22 in this embodiment may include a plurality of first connection lines A, a plurality of second connection lines B and a plurality of bridge lines C. A plurality of the first connection lines A, a plurality of the second connection lines B, and a plurality of the bridge lines C in this embodiment may also be made in one of the materials of indium tin oxide, aluminum, copper, silver, titanium, molybdenum and alloys thereof.

S22a, an insulation layer may be prepared on the connection line layer.

Further, an insulation layer 23 is formed on the touch substrate 10 having the connection line layer 22 described above. The insulation layer 23 may be made of a material such as a transparent adhesive, and may be other materials in other embodiments, and is not further limited herein.

S23a, an electrode layer may be prepared on the insulation layer.

In this embodiment, also combined with referring to FIG. 6, the electrode layer 21 may include a plurality of first electrodes 211 and second electrodes 212 disposed in rows and columns. Adjacent first electrodes 211 of each row are directly connected, and each row of the first electrodes 211 is respectively connected to the solder region through the corresponding first connection line A. Each of the first connection lines A may be insulated from the first electrodes 211 of all the rows except the corresponding row. Optionally, the insulation layer 23 may be disposed between each first connection line A and the first electrodes 211 of all the rows except the corresponding row by action S22a, so that the first connection line A may connect the first electrode 211 of the corresponding row to the solder region (bonding), and be simultaneously insulated from all the first electrodes 211 of the other rows.

A plurality of the bridge lines C may be disposed between adjacent second electrodes 212 of each column for connecting together the second electrodes 212 of the same column. A plurality of the second connection lines B are used for respectively connecting corresponding columns of the second electrodes 212 to the solder region.

In the present disclosure, the shapes, materials, and properties of the first electrodes 211 and the second electrodes 212 in the electrode layer 21 are the same as those in the embodiment mentioned above, and are not described herein again.

S3, preparing a protective layer on the touch electrode layer to form a touch panel.

After the preparation of the touch electrode layer 20 described above is completed, the protective layer 30 may be further deposited. The preparation of the protective layer 30 may be prepared by using conventional materials or techniques, and is not further limited herein.

In this embodiment, by disposing the first connection lines of the connection line layer under the electrode layer, that is, by routing from the inside of the electrode layer, the first connection lines are connected to the solder region, the influence of the edge tracing on the touch panel frame can be avoided. Greatly reduce the width of the display frame border, and even achieve a zero border design.

A touch panel including a touch substrate, a touch electrode layer and a protective layer may also be provided in the present disclosure. The touch electrode layer may be disposed on the touch substrate. The touch electrode layer may include an electrode layer, a connection line layer and an insulation layer. The insulation layer may be disposed between the electrode layer and the connection line layer, and the electrode layer may include a plurality of first electrodes and second electrodes disposed in rows and columns. The connection line layer may include a plurality of first connection lines disposed above or below the electrode layer. Each row of the first electrodes may be respectively connected to the solder region through a corresponding first connection line, as described above and will not be repeated here.

In summary those skilled in the art can easily understand that the present disclosure provides a touch panel and a method for producing the same, by disposing first connection lines in a connection line layer above or below an electrode layer, that is, by routing from the inside of the electrode layer, the first connection lines are connected to the solder region, which can avoid the influence of the edge tracing on the touch panel frame, and greatly reduce the width of the display frame border, or even realize the zero border design.

The above description depicts merely some exemplary embodiments of the disclosure, but is not meant to limit the scope of the disclosure. Any equivalent structure or flow transformations made to the disclosure, or any direct or indirect applications of the disclosure on other related fields, shall all be covered within the protection of the disclosure.

What is claimed is:

1. A touch panel, comprising:
a touch substrate;
a touch electrode layer disposed on the touch substrate and comprising an electrode layer, a connection line layer and an insulation layer disposed between the electrode layer and the connection line layer, wherein the electrode layer comprises a plurality of first electrodes and second electrodes disposed in rows and columns; the connection line layer comprises a plurality of first connection lines disposed above or below the electrode layer, the first electrodes of each row are respectively connected to a solder region through a corresponding first connecting line, and each of the first connecting lines is insulated from the first electrodes of all the rows except the corresponding row;
wherein the electrode layer is disposed on the touch substrate, the insulation layer is disposed on the electrode layer, the connection line layer is disposed on the insulation layer, and the connection line layer comprises a plurality of the first connection lines, a plurality of second connection lines, and a plurality of bridge lines;
the bridge lines are disposed between adjacent second electrodes of each column, for connecting the second electrodes of the same column together, and the second connection lines separately connect each corresponding column of the second electrodes to the solder region; or
wherein the connection line layer is disposed on the touch substrate, comprising a plurality of the first connection lines, a plurality of second connection lines, and a plurality of bridge lines, and the insulation layer is disposed on the connection line layer, the electrode layer is disposed on the insulation layer;
the bridge lines are disposed between adjacent second electrodes of each column for connecting the second electrodes of the same column together, and the second connection lines separately connect each corresponding column of the second electrodes to the solder region; and
a protective layer disposed on the touch electrode layer.

2. The touch panel according to claim 1, wherein the insulation layer is disposed between each of the first connection lines and the first electrodes of all rows except the corresponding row.

3. The touch panel according to claim 1, wherein a material of the electrode layer and the connection line layer is one of indium tin oxide, aluminum, copper, silver, titanium, and molybdenum.

4. A touch panel, comprising:
a touch substrate;
a touch electrode layer disposed on the touch substrate and comprising an electrode layer, a connection line layer and an insulation layer disposed between the electrode layer arid the connection line layer, wherein the electrode layer comprises a plurality of first electrodes and second electrodes disposed in rows and columns, the connection line layer comprises a plurality of first connection lines disposed above or below the electrode layer, the first electrodes of each row are respectively connected to a solder region though a corresponding first connecting line, and each of the first connecting lines is insulated from the first electrodes of all the rows except the corresponding row; and
a protective layer disposed on the touch electrode layer.

5. The touch panel according to claim 4, wherein the electrode layer is disposed on the touch substrate, the insulation layer is disposed on the electrode layer, the connection line layer is disposed on the insulation layer, and the connection line layer comprises a plurality of the first connection lines, a plurality of second connection lines, and a plurality of bridge lines;
the bridge lines are disposed between adjacent second electrodes of each column, for connecting the second electrodes of the same column together, and the second connection lines separately connect each corresponding column of the second electrodes to the solder region.

6. The touch, panel according to claim 4, wherein the connection line layer is disposed on the touch substrate, comprising a plurality of the first connection lines, a plurality of second connection lines, and a plurality of bridge lines, and the insulation layer is disposed on the connection line layer, the electrode layer is disposed on the insulation layer;
the bridge lines are disposed between adjacent second electrodes of each column, for connecting the second electrodes of the same column together, and the second connection lines separately connect each corresponding column of the second electrodes to the solder region.

7. The touch panel according to claim 4, wherein the insulation layer is disposed between each of the first connection lines and the first electrodes of all rows except the corresponding row.

8. The touch panel according to claim 5, wherein the insulation layer is disposed between each of the first connection lines and the first electrodes of all rows except the corresponding row.

9. The touch panel according to claim 6, wherein the insulation layer is disposed between each of the first connection lines and the first electrodes of all rows except the corresponding row.

10. The touch panel according to claim 4, wherein the material of the electrode layer and the connection line layer is one of indium tin oxide, aluminum, copper, silver, titanium, and molybdenum.

11. A method of producing a touch panel, wherein the method comprises:
providing a touch substrate;
preparing a touch electrode layer on the touch substrate; wherein
the touch electrode layer comprises an electrode layer, a connection line layer and an insulation, layer disposed between the electrode layer and the connection line layer, the electrode layer comprises a plurality of first electrodes and second electrodes disposed in rows and columns, the connection line layer comprises a plurality of first connection lines disposed above or below the electrode layer, the first electrodes of each row are respectively connected to a solder region through a corresponding first connecting line, and each of the first connecting lines is insulated from the first electrodes of all the rows except the corresponding row; and
preparing a protective layer on the touch electrode layer as to form the touch panel.

12. The method according to claim 11, wherein the preparing the touch electrode layer on the touch substrate comprises:
preparing the electrode layer on the touch substrate;
preparing the insulation layer on the electrode layer;
preparing the connection line layer on the insulation layer, the connection line layer comprising a plurality of first connection lines, a plurality of second connection lines, and a plurality of bridge lines;
wherein the bridge lines are disposed between adjacent second electrodes of each column for connecting the second electrodes of the same column, and the second connection lines are configured to separately connect the corresponding second electrodes of each column to the solder region.

13. The method according to claim 11, wherein the preparing the touch electrode layer on the touch substrate comprises:
preparing the connection line layer on the touch substrate, the connection line layer comprising a plurality of first connection lines, a plurality of second connection lines, and a plurality of bridge lines;
preparing the insulation layer on the connection line layer;
preparing the electrode layer on the insulation layer;
wherein the bridge lines are disposed between adjacent second electrodes of each column for connecting the second electrodes of the same column, and the second connection lines are configured to separately connect the corresponding second electrodes of each column the solder region.

14. The method according to claim 11, wherein the insulation layer is disposed between each of the first connection lines and the first electrodes of all rows except the corresponding row.

15. The method according to claim 12, wherein the insulation layer is disposed between each of the first connection lines and the first electrodes of all rows except the corresponding row.

16. The method according to claim 13, wherein the insulation layer is disposed between each of the first connection lines and the first electrodes of all rows except the corresponding row.

17. The method according to claim 11, wherein the material of the electrode layer and the connection line layer is one of indium tin oxide, aluminum, copper, silver, titanium, and molybdenum.
